(19) United States
(12) Patent Application Publication
(10) Pub. No.: US 2015/0319655 A1
(43) Pub. Date: Nov. 5, 2015

(54) HANDLING OF DIFFERENT TYPES OF THRESHOLDS IN MEASUREMENT REPORTING

(71) Applicant: Nokia Technologies Oy, Espoo (FI)

(72) Inventors: Jussi-Pekka KOSKINEN, Oulu (FI); Jarkko KOSKELA, Oulu (FI); Lars DALSGAARD, Oulu (FI)

(21) Appl. No.: 14/650,307

(22) PCT Filed: Dec. 12, 2013
(86) PCT No.: PCT/FI2013/051158

§ 371 Date: Jun. 7, 2015

Related U.S. Application Data
(60) Provisional application No. 61/740,405, filed on Dec. 20, 2012.

(51) Int. Cl. H04W 36/00; H04W 60/04; H04W 48/20

(52) U.S. Cl. CPC H04W 36/0083; H04W 48/20; H04W 60/04; H04W 88/02

(57) ABSTRACT

Methods and apparatus, including computer program products, are provided for handling different types of triggering quantities for a measurement reporting event such that user equipment behavior is predictable. Related apparatus, systems, methods, and articles are also described.

### FIELD

The subject matter disclosed herein relates to wireless communications.

### BACKGROUND

A user equipment, such as a mobile wireless device and the like, may be mobile in the sense that the user equipment may enter and/or exit a plurality of cells that serve the user equipment with access to, and from, the public land mobile network. For example, when the user equipment is being served by a cell, the user equipment may be configured to measure the serving cell and/or other cells, and then report measurements of the serving cell and/or other cells to the network. The network may then decide whether to handover the user equipment to another cell, and the handover may be implemented for a variety of reasons (e.g., in order to couple to a better serving cell, increase capacity, and the like). In any case, if the network decides that a handover should be performed, the network may send a handover command to network nodes and/or the user equipment.

### SUMMARY

In some example embodiments, there is provided a method for handling different types of measurements.

In some example embodiments, there may be provided a method. The method may include sending configuration information including a single threshold quantity for use with different types of measurement thresholds for a measurement event; and receiving a measurement event report triggered based on the sent single threshold quantity.

In some example embodiments, there may also be provided a method. The method may include receiving, by a user equipment, configuration information including a single threshold quantity for use with different types of measurement thresholds for a measurement event; and triggering, based on the received single threshold quantity, reporting of the measurement event by the user equipment.

In some variations, one or more of the features disclosed herein including the following features can optionally be included in any feasible combination. The configuration information may be sent when the user equipment does not support the different types of measurement thresholds. The configuration information may be sent when the user equipment does not signal to a network node support for the different types of measurement thresholds. The different types of measurement thresholds may include a first threshold and a second threshold. The first threshold and the second threshold may be set to a value of the single threshold quantity. The first threshold may include a reference signal, received quality type, and the second threshold may include a reference signal, received power type. The measurement event may include event A5. In response to a received indication that a user equipment supports different types of measurement thresholds for the measurement event, configuration information including different threshold quantities may be sent to configure the different types of measurement thresholds at the user equipment.

Articles are also described that comprise a tangibly embodied computer-readable medium embodying instructions that, when performed, cause one or more machines (e.g., computers, etc.) to result in operations described herein. Similarly, apparatus are also described that can include a processor and a memory coupled to the processor. The memory can include one or more programs that cause the processor to perform one or more of the operations described herein.

It is to be understood that both the foregoing general description and the following detailed description are exemplary and explanatory only and are not restrictive. Further features and/or variations may be provided in addition to those set forth herein. For example, the implementations described herein may be directed to various combinations and subcombinations of the disclosed features and/or combinations and subcombinations of several further features disclosed below in the detailed description.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the subject matter disclosed herein. In the drawings,

FIG. 1 depicts an example of a system, in accordance with some example embodiments;

FIG. 2 depicts an example of a process for handling different types of thresholds and quantities of those thresholds to define an event, which may be reported to the network, in accordance with some example embodiments;

FIG. 3 depicts an example of a radio, in accordance with some example embodiments; and

FIG. 4 depicts an example of a wireless access point, in accordance with some example embodiments.

Like labels are used to refer to same or similar items in the drawings.

### DETAILED DESCRIPTION

Events representative of different criteria can be established at a user equipment to trigger reporting measurements to the network in order to determine whether a handover should be performed. One of those events is referred to as Event A5, in accordance with, for example, 3GPP TS 36.331. In the case of Event A5, when a measurement of the primary cell (PCell) becomes worse than a first threshold and a measurement of the neighboring cell becomes better than a second threshold, this may satisfy the criteria for Event A5 and trigger the user equipment to send a measurement report, including measured quantities, to the network. This measurement report allows the network to determine whether a handover should be performed to another cell, such as the neighboring cell.

In some example embodiments, the subject matter disclosed herein may relate to the user equipment signaling to the network whether the user equipment supports different types of thresholds having different measurement quantities and/or, in response to the signaling, the network configuring the user equipment with different types of thresholds having different measurement quantities. Referring again to the A5 measurement report example, the user equipment may signal that it supports different types of thresholds having different quantities. The network may then configure the user equipment with, for example, a first threshold in terms of RSRP and a second, different threshold in terms of RSRQ, and these thresholds may be used as event criteria, such as A5 Event criteria and/or the like (although other events may be used and/or defined as well).

Although the previous example refers to the first threshold in terms of terms of RSRP and the second threshold in terms of RSRQ, the first threshold may instead be configured in terms of terms of RSRQ and the second threshold in terms of RSRP. Moreover, although some of the examples described herein refer to the different types of measurements as including RSRQ and RSRP, other types of measurements may be used as well.

In some example embodiments, the user equipment may signal its capabilities representative of different types of thresholds and different measurement quantities to the network by using a feature group indicator (FGI), a release indication from the user equipment, and/or any other capability signaling. This capabilities signaling may make the network explicitly aware of the capabilities of the user equipment to support different measurement quantities for, and types of, thresholds of an event. If such capabilities are not provided by the user equipment, the UE may assume that network always configures the same quantities for the thresholds.

Although some of the examples disclosed herein refer to the A5 Event, the different types of thresholds and measurement quantities may be used in other events including newly defined events (for example, an A7 Event), enabling usage of different quantities for, and types of, thresholds/offsets of the events and the like. For example, a new event may be defined and configured at the user equipment to enable the user equipment to handle different types of thresholds and quantities of those thresholds to define the new event.

Before providing additional examples, the following provides an example of a system framework in which some of the example embodiments described herein may be implemented.

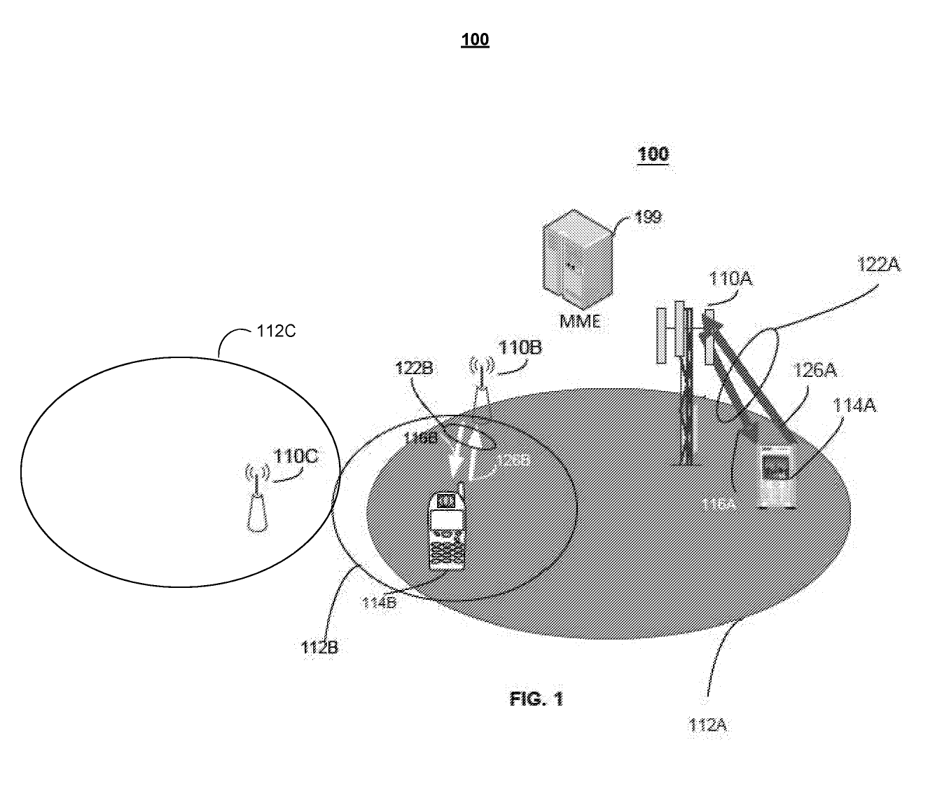

FIG. 1 depicts a system 100 according to some example embodiments. System 100 may include one or more user equipment, such as user equipment 114A-B, and one or more access points, such as base stations 110A-C. In some example embodiments, base station 110A may serve a cell, such as macrocell 112A, and base station 110B may serve a small cell, such as a picocell or a femtocell 112B, although base stations 110A-B may serve other types of cells as well. In other examples the cells (that being either macro cells or small cells) may be co-located. Moreover, the base stations 110A-C may have wired and/or wireless backhaul links to other network nodes, such as a mobility management entity (MME) 199, other base stations, a radio network controller, a core network, a serving gateway, and/or the like. Moreover, the system 100 may be configured to operate using carrier aggregation, although operation without carrier aggregation may be implemented as well.

In some example embodiments, user equipment 114A-B may be implemented as a mobile device and/or a stationary device. The user equipment 114A-B are often referred to as, for example, mobile stations, mobile units, subscriber stations, wireless terminals, tablets, smart phones, a wireless handheld device, a wireless plug-in accessory, or the like. In some example embodiments, the user equipment may include one or more processors, one or more computer-readable storage medium (for example, memory, storage, and/or the like), one or more radio access components (for example, a modem, a transceiver, and/or the like), and/or a user interface.

In some example embodiments, the user equipment 114A-B may be implemented as multi-mode user devices configured to operate using a plurality of radio access technologies, although a single-mode device may be used as well. For example, user equipment 114A-B may be configured to operate using a plurality of radio access technologies including one or more of the following: Long Term Evolution (LTE), wireless local area network (WLAN) technology, such as 802.11 WiFi and/or the like, Bluetooth, Bluetooth low energy (BT-LE), near field communications (NFC), and any other radio access technologies. Moreover, the user equipment 114A-B may be configured to have established connections to access points using a plurality of the radio access technologies.

The base stations 110A-C may, in some example embodiments, be implemented as an evolved Node B (eNB) type base station, although other types of radio, access points may be implemented as well. When the evolved Node B (eNB) type base station is used, the base stations, such as base stations 110A-C, may be configured in accordance with standards, including the Long Term Evolution (LTE) standards, such as 3GPP TS 36.201, Evolved Universal Terrestrial Radio Access (E-UTRA), Long Term Evolution (LTE) physical layer, General description, 3GPP TS 36.211, Evolved Universal Terrestrial Radio Access (E-UTRA), Physical channels and modulation, 3GPP TS 36.212, Evolved Universal Terrestrial Radio Access (E-UTRA), Multiplexing and channel coding, 3GPP TS 36.213, Evolved Universal Terrestrial Radio Access (E-UTRA), Physical layer procedures, 3GPP TS 36.214, Evolved Universal Terrestrial Radio Access (E-UTRA), Physical layer—Measurements Protocol specification, 3GPP TS 36.331, Technical Specification Group Radio Access Network, Evolved Universal Terrestrial Radio Access (E-UTRA), Radio Resource Control (RRC), and any subsequent additions or revisions to these and other 3GPP series of standards (collectively referred to as LTE standards). The base stations 110A-C may also be configured to serve cells using a WLAN technology, such as WiFi (for example, the IEEE 802.11 series of standards), as well as any other radio access technology capable of serving a cell.

In some example embodiments, system 100 may include access links, such as links 122A-B. The access links 122A may include a downlink 116A for transmitting to the user equipment 114A and an uplink 126A for transmitting from user equipment 114A to the base station 110A. The downlink 116A may comprise a modulated radio frequency carrying information, such as user data, radio resource control (RRC) messages, information configuring a user equipment, handover commands, and/or the like, to the user equipment 114A, and the uplink 126A may comprise a modulated radio frequency carrying information, such as user data, RRC messages, user equipment capabilities reporting, measurement reports, and/or the like, from the user equipment 114A to base station 110A. Access links 122B may include downlink 116B for transmitting from the base station 110B to user equipment 114B, and uplink 126B for transmitting from user equipment 114B to the base station 110B.

The downlink 116A and uplinks 126A may, in some example embodiments, each represent a radio frequency (RF) signal. The RF signal may, as noted above, carry data, such as voice, video, images, Internet Protocol (IP) packets, control information, and any other type of information and/or messages. For example, when LTE is used, the RF signal may use OFDMA. OFDMA is a multi-user version of orthogonal frequency division multiplexing (OFDM). In OFDMA, multiple access is achieved by assigning, to individual users, groups of subcarriers (also referred to as subchannels or tones). The subcarriers are modulated using BPSK (binary phase shift keying), QPSK (quadrature phase shift keying), or QAM (quadrature amplitude modulation), and carry symbols (also referred to as OFDMA symbols) including data coded using a forward error-correction code. The subject matter described herein is not limited to application to OFDMA systems, LTE, LTE-Advanced, or to the noted standards, specifications, and/or technologies. Furthermore, the downlink 116B and uplink 126B may be configured using standards and/or technologies similar to those noted with respect to downlink 116A and uplink 126A, although downlink 116B and uplink 126B may use different standards or technologies as well, such as WiFi, WiBro, and/or another other wireless technology. In addition, each access link may be unidirectional or bidirectional. The subject matter described herein is not limited to application to OFDMA systems, LTE, LTE-Advanced, or to the noted standards, specifications, and/or technologies described herein.

Although FIG. 1 depicts access links between certain user equipment and certain base stations, the user equipment and base stations may have additional links to other devices as well. Furthermore, although FIG. 1 depicts a specific quantity and configuration of base stations, cells, and user equipment, other quantities and configurations may be implemented as well.

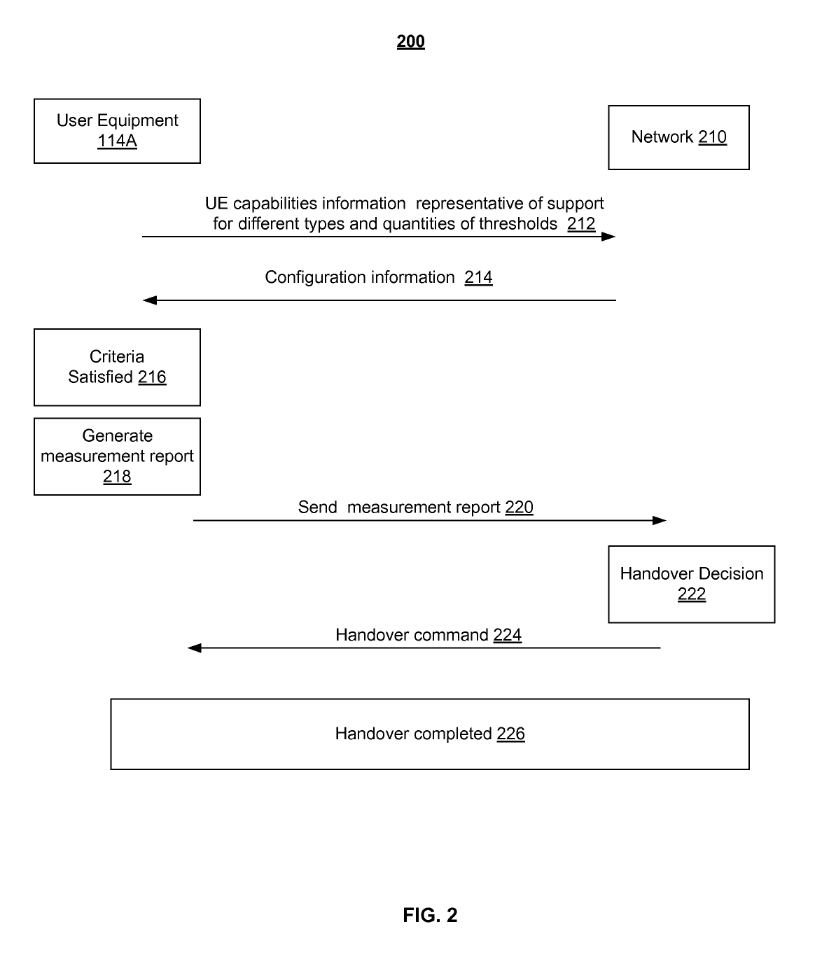

FIG. 2 depicts an example of a process 200 for configuring events with different quantities for different types of thresholds associated with an event, in accordance with some example embodiments.

At 212, the user equipment 114A may send to network 210, such as base station 110A and the like, capabilities information including an indication representative of whether the user equipment 114A supports different types of thresholds and/or different measurement quantities, in accordance with some example embodiments. For example, user equipment 114A may send feature group indicators in accordance with 3GPP TS 36.331, but the feature group indicators may be configured to further include an indicator representative of whether different types of thresholds (and/or different measurement quantities) are supported by the user equipment 114A.

Referring again to the A5 Event example, a first threshold and a corresponding triggering quantity may be defined in terms of RSRP, and a second threshold and a corresponding triggering quantity may be defined in terms of RSRQ, although other types may be used as well. These trigger quantities represents different measurements quantities used to trigger the A5 event. In this example, the feature group indicators may provide capability information to the network, and the feature group indicator may include an indicator representative of user equipment 114A supporting different types of thresholds (e.g., RSRP and RSRQ) and different, measurement quantities (for example, a first threshold quantity and a different second threshold quantity) in the same event, in accordance with some example embodiments. And, the indicator may represent the specific type of threshold used with a primary cell and another type used with a neighboring cell. Although the previous example refers to the A5 Event, other events may be used and/or other events may be defined to support handling different types of triggering quantities for a measurement reporting event, which may, in some example embodiments, make the user equipment's behavior more predictable.

Although the previous example refers to using the feature group indicators to signal to the network the capabilities of the user equipment, the indication representative of whether the user equipment supports different types of thresholds and different types of measurement quantities for an event, such as an A5 Event and the like, may be signaled to the network in other types of messages and/or information elements.

At 214, the network 210 may send information to configure the user equipment, in accordance with some example embodiments. And, the configuration information may, in some example embodiments, include different types of thresholds and different measurement quantities. For example, the configuration information may represent a first threshold value in terms of RSRP and a second, different threshold value in terms of RSRQ.

In some example embodiments, network 210 may configure the user equipment 114A to use the same triggering quantity for both thresholds, when the user equipment does not explicitly indicate at 212 support for different triggering quantities. The network may need to use the same thresholds quantities if user equipment does not expressly indicate support for different triggering quantities for an event, so that the user equipment behavior is clear and predictable, rather than unpredictable.

At 216, the user equipment 114A may determine whether the event criteria have been satisfied, in accordance with some example embodiments. Referring again to the A5 Event example, when a measurement of the primary cell (PCell), such as cell 112A, becomes worse than a first threshold quantity (which may be in terms of terms of RSRP) and a measurement of the neighboring cell, such as a secondary cell, cell 112B, or cell 112C, becomes better than a second, different threshold quantity (which may be in terms of RSRQ), this may satisfy the criteria for the A5 Event, triggering thus user equipment 114A to generate a measurement report at 218 and send at 220 the generated report to the network.

Although the previous example refers to the first threshold in terms of terms of RSRP and the second threshold in terms of RSRQ, the first threshold may, as noted, be configured in terms of terms of RSRQ and the second threshold in terms of RSRP. Moreover, the thresholds may be used with events other than the A5 Event.

At 220, the user equipment 114A may send the measurement report to the network 210, in accordance with some example embodiments. For example, user equipment 114A may send the measurement report indicating that an event, having different types of thresholds and different quantities, has been satisfied (for example, the A5 Event criteria). In some example embodiments, the information element TriggeringQuantity, as disclosed in 3GPP TS 36.331, is defined so that it is only used for ordering measurement results, but the thresholds information elements may be used to indicate different threshold values for each of the different types of triggering quantities as follows:

| (ThresholdEUTRA ::= CHOICE{ | |
|---|---|
| threshold-RSRP | RSRP-Range, |
| threshold-RSRQ | RSRQ-Range. |
| | }. |

Although the previous example describes threshold information elements, a new event may be defined to clearly indicate that the thresholds may be configured to have different quantities.

At 222, the network may, in accordance with some example embodiments, make a handover decision based on the measurement report received at 220, which may enable a handover command at 224 and a completion of the handover at 226.

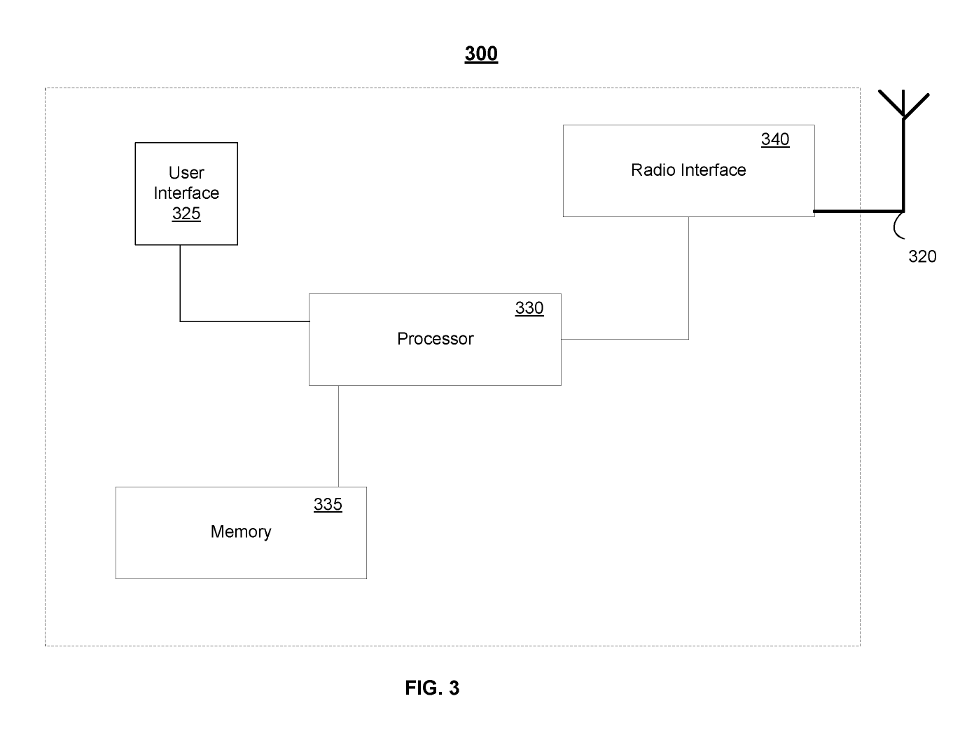

FIG. 3 depicts a block diagram of a radio 300 that may be used at user equipment 114A-B, in accordance with some example embodiments. The user equipment may include one or more antennas 320 for receiving a downlink and transmitting via an uplink. The user equipment 300 may also include a radio interface 340 (also referred to as a modem) coupled to the antenna 320. The radio interface 340 may correspond to a plurality of radio access technologies including one or more of LTE, WLAN, Bluetooth, BT-LE, NFC, RFID, UWB, ZigBee, and/or the like. The radio interface 340 may include other components, such as filters, converters (for example, digital-to-analog converters and the like), symbol demappers, signal shaping components, an Inverse Fast Fourier Transform (IFFT) module, and/or the like, to process symbols, such as OFDMA symbols, carried by a downlink or an uplink. The user equipment 300 may further include a user interface 325, at least one processor, such as processor 330, for controlling user equipment 300 and for accessing and executing program code stored in memory 335.

In some example embodiments, the memory 435 includes code, which when executed by at least one processor causes one or more of the operations described herein with respect to user equipment, such as process 200 and the like. For example, the user equipment may send to the network capabilities information including an indication of whether different measurement types and quantities are supported, make measurements of cells in accordance with signaling from the network, send a measurement report including measured quantities having different types, such as RSRQ and RSRP, handover to a neighboring cell, and/or perform any other operations associated with the user equipment disclosed herein.

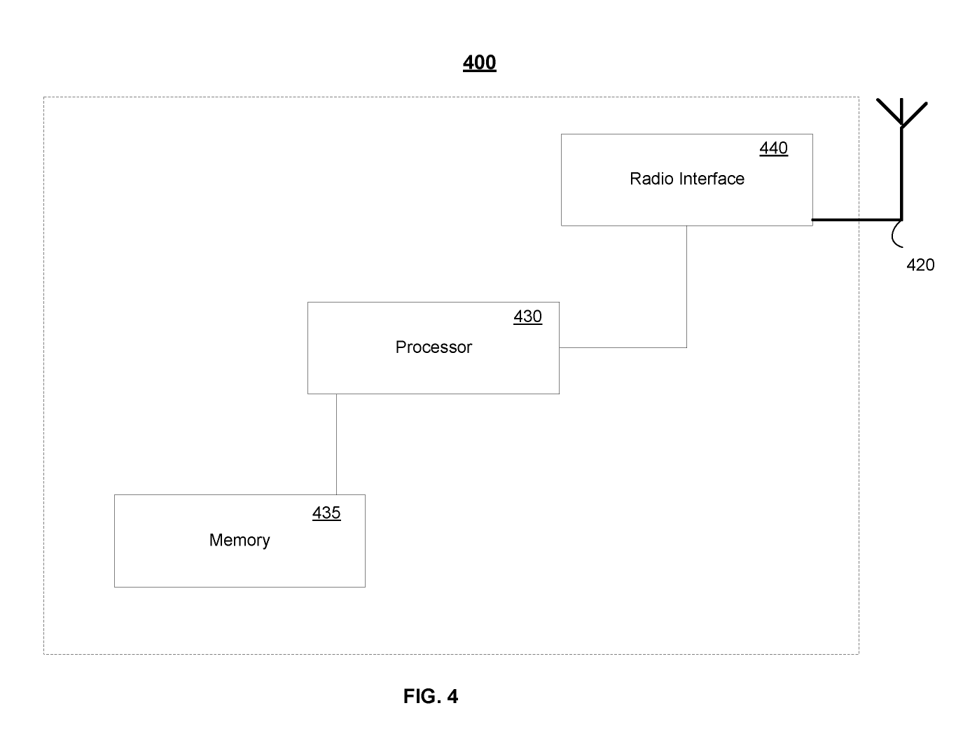

FIG. 4 depicts an example implementation of a wireless access point 400, such as a base station that can be implemented at one or more of base stations 110A-C and the like, in accordance with some example embodiments. The wireless access point may include one or more antennas 420 configured to transmit via downlinks and configured to receive uplinks via the antenna(s) 420. The wireless access point may further include a plurality of radio interfaces 440 coupled to the antenna(s) 420. The radio interfaces 440 may correspond to a plurality of radio access technologies including one or more of LTE, WLAN, Bluetooth, BT-LE, NFC, radio frequency identifier (RFID), ultrawideband (UWB), ZigBee, and/or the like. The radio interface 440 may include components, such as filters, converters (for example, digital-to-analog converters and the like), mappers, a Fast Fourier Transform (FFT) module, and/or the like. The wireless access point may further include one or more processors, such as processor 430, for controlling the wireless access point 400 and for accessing and executing program code stored in memory 435. In some example embodiments, the memory 435 includes code, which when executed by at least one processor, causes one or more of the operations described herein with respect to the base stations/wireless access points. For example, the wireless access point 400 may be configured to send to the network capabilities information including an indication of whether the user equipment is configured to handle a plurality of different types of thresholds for the plurality of different types, signal measurement configurations including thresholds and types to the user equipment, receive a measurement report including measured quantities having different types, such as RSRQ and RSRP, send handover commands, and/or perform any other operations associated with a base station of network disclosed herein.

Without in any way limiting the scope, interpretation, or application of the claims appearing herein, a technical effect of one or more of the example embodiments disclosed herein may, in some example implementations, include enhanced predictability of user equipment operation.

The subject matter described herein may be embodied in systems, apparatus, methods, and/or articles depending on the desired configuration. For example, the base stations and user equipment (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “computer-readable medium” refers to any non-transitory computer program product, machine-readable medium, computer-readable storage medium, apparatus and/or device (for example, magnetic discs, optical disks, memory, Programmable Logic Devices (PLDs)) used to provide machine instructions and/or data to a programmable processor, including a non-transitory machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. Moreover, the implementations described above may be directed to various combinations and subcombinations of the disclosed features and/or combinations and subcombinations of several further features disclosed above. Other embodiments may be within the scope of the following claims.

The different functions discussed herein may be performed in a different order and/or concurrently with each other. Furthermore, one or more of the above-described functions may be optional or may be combined. Although various aspects of the invention are set out in the independent claims, other aspects of the invention comprise other combinations of features from the described embodiments and/or the dependent claims with the features of the independent claims, and not solely the combinations explicitly set out in the claims. It is also noted herein that while the above describes example embodiments of the invention, these descriptions should not be viewed in a limiting sense. Rather, there are several variations and modifications, which may be made without departing from the scope of the present invention as, defined in the appended claims. The term “based on” includes “based on at least.”

1-36. (canceled)

37. A method comprising:
sending configuration information including a single threshold quantity for use with different types of measurement thresholds for a measurement event; and
receiving a measurement event report triggered based on the sent single threshold quantity from a user equipment.

38. A method as in claim 37, wherein the configuration information is sent when an indication from the user equipment indicating that the user equipment supports the different types of measurement thresholds is not received.

39. A method as claim 37, wherein the different types of measurement thresholds include a first threshold and a second threshold.

40. A method as in claim 39, further comprising:
setting the first threshold and the second threshold to a value of the single threshold quantity.

41. A method as in claim 37, further comprising:
sending, in response to a received indication that a user equipment supports different types of measurement thresholds for the measurement event, configuration information including different threshold quantities to configure the different types of measurement thresholds at the user equipment.

42. An apparatus, comprising:
at least one processor; and
at least one memory including computer program code, the at least one memory and the computer program code configured to, with the at least one processor, cause the apparatus to perform at least the following:
send configuration information including a single threshold quantity for use with different types of measurement thresholds for a measurement event; and
receive a measurement event report triggered based on the sent single threshold quantity from a user equipment.

43. The apparatus of claim 42, wherein the configuration information is sent when the user equipment does not support the different types of measurement thresholds or when the apparatus does not receive an indication from the user equipment indicating that the user equipment supports the different types of measurement thresholds.

44. An apparatus as in claim 42, wherein the different types of measurement thresholds include a first threshold and a second threshold.

45. An apparatus as in claim 44, wherein the apparatus is further caused to at least set the first threshold and the second threshold to a value of the single threshold quantity.

46. An apparatus as in claim 42, wherein the apparatus is further caused to at least send, in response to a received indication that a user equipment supports different types of measurement thresholds for the measurement event, configuration information including different threshold quantities to configure the different types of measurement thresholds at the user equipment.

47. A method comprising:
receiving, by a user equipment, configuration information including a single threshold quantity for use with different types of measurement thresholds for a measurement event; and
triggering, based on the received single threshold quantity, reporting of the measurement event by the user equipment.

48. The method of claim 47, wherein the user equipment receives the configuration information, when the user equipment does not support the different types of measurement thresholds or when the user equipment does not explicitly signal to a network node support the different types of measurement thresholds.

49. A method as in claim 47, wherein the different types of measurement thresholds include a first threshold and a second threshold, wherein the first threshold and the second threshold are set to the single threshold quantity.

50. A method as in claim 47, further comprising:
sending an indication that the user equipment supports different type of measurement threshold for measurement event.

51. A method as in claim 50, further comprising:
receiving configuration information including different threshold quantities to configure the different types of measurement threshold at the user equipment.

52. An apparatus, comprising:
at least one processor; and
at least one memory including computer program code, the at least one memory and the computer program code configured to, with the at least one processor, cause the apparatus to perform at least the following:
receive, configuration information including a single threshold quantity for use with different types of measurement thresholds for a measurement event; and
trigger, based on the received single threshold quantity, reporting of the measurement event.

53. The apparatus of claim 52, wherein the apparatus comprises a user equipment further configured to at least receive the configuration information, when the user equipment does not support the different types of measurement thresholds or when the user equipment does not explicitly signal to a network node support the different types of measurement thresholds.

54. An apparatus as in claim 52, wherein the different types of measurement thresholds include a first threshold and a second threshold, wherein the first threshold and the second threshold are set to the single threshold quantity.

55. An apparatus as in claim 52, wherein the apparatus is further caused to send an indication that the apparatus supports different type of measurement thresholds for the measurement event.

56. An apparatus as in claim 55, wherein the apparatus is further caused to receive configuration information including different threshold quantities to configure the different types of measurement thresholds.
